(19) United States
(12) Patent Application Publication
(10) Pub. No.: US 2009/0080213 A1
(43) Pub. Date: Mar. 26, 2009

(54) Light guide and image sensor module

(75) Inventors: Hiroaki Onishi, Kyoto-shi (JP); Hideki Sawada, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/283,235

(22) Filed: Sep. 10, 2008

(30) Foreign Application Priority Data
Sep. 26, 2007 (JP) 2007-249219

(51) Int. Cl. G02B 6/00; F21V 33/00

(52) U.S. Cl. 362/551; 362/253

(57) ABSTRACT

An elongated and generally columnar light guide includes a light receiving surface provided at an longitudinal end portion of the light guide, a reflecting surface elongated in the longitudinal direction of the light guide for reflecting light entering through the light receiving surface in a light emitting direction, a ridge elongated in the longitudinal direction of the light guide, and a light emitting surface for emitting reflected light from the reflecting surface as linear light extending in the longitudinal direction of the light guide. The reflecting surface is provided on a distal end portion of the ridge.

### BACKGROUND OF THE INVENTION

1. Field of the Invention

The present invention relates to a light guide used for e.g. a flat bed scanner, and also to an image sensor module.

2. Description of the Related Art

FIG. 7 depicts an example of a conventional light guide, and an image sensor module incorporating the light guide (see JP-A-H09-275469, for example). The illustrated image sensor module X includes a substrate 91, a light source module 92, a plurality of sensor IC chips 93, a light guide 94, and a housing 95. On the substrate 91, the sensor IC chips 93 are aligned in the primary scanning direction x. The light source module 92 includes three LED chips 92a for emitting red light, green light and blue light, respectively.

The light guide 94 is elongated in the primary scanning direction x. The light guide 94 includes a light receiving surface 94a, a reflecting surface 94b, and a light emitting surface 94c. Light emitted from the light source module 92 is introduced into the light guide 94 via the light receiving surface 94a. The reflecting surface 94b includes a plurality of grooves, each extending in a direction perpendicular to the primary scanning direction x, and spaced from each other in the primary scanning direction x. The light proceeding inside the light guide 94 is reflected by the grooves in the reflecting surface 94b, toward the light emitting surface 94c. Linear light, extending in the primary scanning direction x, is emitted from the light emitting surface 94c. The linear light irradiates an object to be read, and the sensor IC chip 93 detects the reflected light.

In the image sensor module X, the light that has reached the grooves of the reflecting surface 94b is reflected by the inclined surface of the grooves generally in the same direction. In the conventional arrangement, however, the linear light emitted through the light emitting surface 94c will have undesired peaks in the light intensity that correspond to the pitch of the mutually spaced grooves. In other words, a significant fluctuation in illuminance will result on the object to be read in the primary scanning direction x, whereby the quality of the obtained image deteriorates. A solution to equalize the light intensity over the linear light may be narrowing the groove pitch. With a reduced groove pitch, however, when the light guide 94 is produced by an injection molding process, extremely high dimensional accuracy is required in the mold. This imposes difficulty in producing the mold, and hence the light guide.

### SUMMARY OF THE INVENTION

The present invention has been proposed under the circumstances described above. It is therefore an object of the present invention to provide a light guide that can be manufactured by a simple process, and yet provide linear light of equalized intensity over the light emitting surface of the light guide. Another object of the present invention is to provide an image sensor module having such a light guide incorporated therein.

According to a first aspect of the present invention, there is provided a light guide that is elongated in a predetermined direction and generally columnar in shape. The light guide comprises: a light receiving surface provided at an longitudinal end portion of the light guide; a reflecting surface elongated in a longitudinal direction of the light guide for reflecting light entering through the light receiving surface in a light emitting direction; a ridge elongated in the longitudinal direction; and a light emitting surface for emitting reflected light (which comes from the reflecting surface) as linear light which extends in the longitudinal direction. The reflecting surface is provided on a distal end portion of the ridge.

In the light guide having the above configuration, the reflecting surface is provided on the distal end portion of the ridge that is simply elongated in the longitudinal direction of the light guide. Such a reflecting surface can be produced more easily than the conventional undulating reflecting surface shown in FIG. 7. In addition, the reflecting surface of the present invention does not lead to the occurrence of discrete peaks of light intensity corresponding to the conventional groove pitch. Thus, the equalizing of the light intensity over the light emitting surface can be attained.

Preferably, the reflecting surface may be produced by applying white paint to the distal end portion of the ridge. In another preferred embodiment, the reflecting surface may be produced by finely roughening the distal end portion of the ridge. To this end, the mold used for forming the light guide may have a finely roughened part corresponding in position to the distal end portion of the ridge. Alternatively, conventionally known blasting may be performed with respect to the distal end.

Preferably, the above-mentioned ridge may include a region whose width continuously increases as proceeding away from the light receiving surface in the longitudinal direction. In general, the amount of light traveling through the light guide tends to decrease as proceeding away from the light receiving surface. The foregoing configuration of the present invention makes it possible to equalize the light intensity over the entire length of the linear light going out from the light emitting surface.

In a preferred embodiment of the present invention, the light guide further comprises a rib portion projecting perpendicular to the longitudinal direction and in a different direction from the light emitting direction, located on an outer surface of the light guide and on the respective sides of the light emitting surface.

A second aspect of the present invention provides an image sensor module that comprises the light guide according to the first aspect of the present invention. The image sensor module also comprises: a light source module adjacent to the light guide; a housing accommodating the light guide; and a plurality of photosensors aligned in a longitudinal direction of the light guide for detecting linear light reflected by an object to be read.

Preferably, the light guide used for the image sensor module may further comprise a pair of rib portions flanking the light emitting direction. Each of the rib portions projects in a direction perpendicular to the longitudinal direction and different from the light emitting direction. The housing is formed with grooves that are elongated in the longitudinal direction of the light guide and arranged to come into engagement with the rib portions of the light guide.

Other features and advantages of the present invention will become more apparent through the detailed description given below with reference to the accompanying drawings.

### BRIEF DESCRIPTION OF THE DRAWINGS

FIG. 1 is a fragmentary cross-sectional view of an image sensor module according to the present invention;

FIG. 2 is a cross-sectional view taken along a line II-II in FIG. 1;

FIG. 3 is a cross-sectional view taken along a line III-III in FIG. 1;

FIG. 4 is a fragmentary cross-sectional view of a light guide according to the present invention;

FIG. 5 is a fragmentary bottom view of the light guide according to the present invention;

FIG. 6 is a cross-sectional view taken along a line VI-VI in FIG. 4; and

FIG. 7 is a fragmentary cross-sectional view of a conventional image sensor module.

### DETAILED DESCRIPTION OF THE PREFERRED EMBODIMENTS

Preferred embodiment of the present invention will be described below with reference to the drawings.

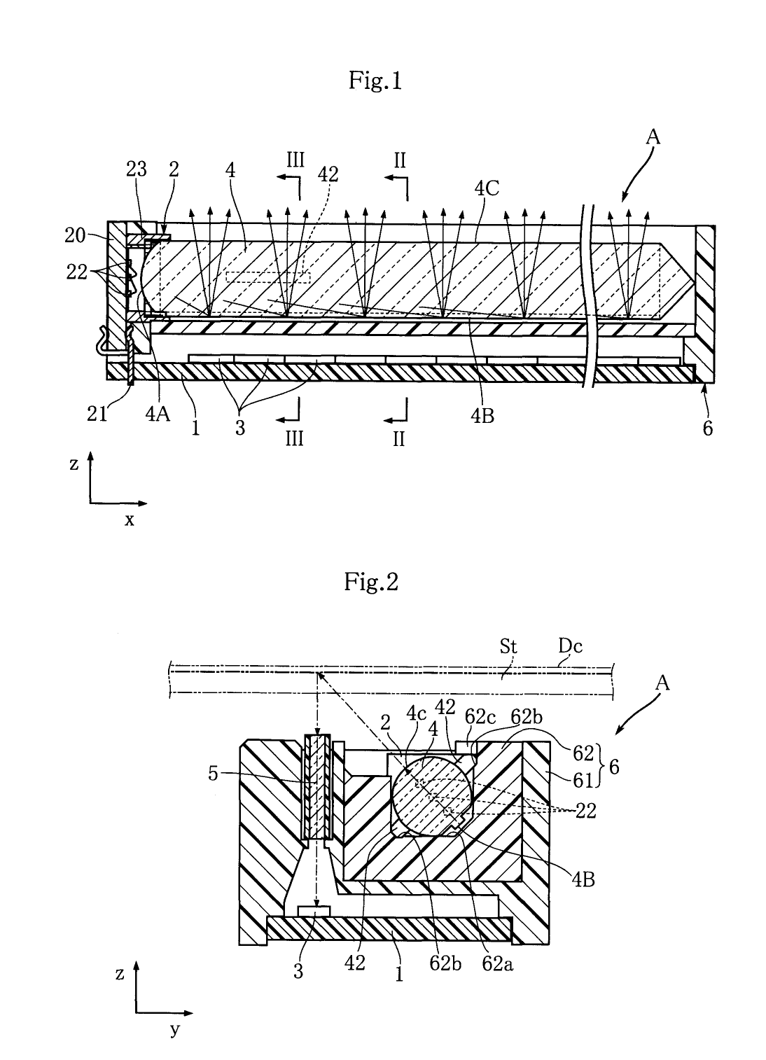

FIGS. 1 to 3 illustrate an image sensor module according to the present invention, and FIGS. 4 to 6 depict a light guide used for the image sensor module. The illustrated image sensor module A includes a substrate 1, a light source module 2, a plurality of sensor IC chips 3, a light guide 4, a lens array 5, and a housing 6. As shown in FIG. 2, the image sensor module A is configured to move in a secondary scanning direction y relatively to a document Dc placed on a document supporting panel St, to read out the content printed on the document Dc.

Referring to FIGS. 1 and 2, the substrate 1 is constituted of a ceramic such as alumina or aluminum nitride, and of a sleek rectangular shape having its longer side oriented in the primary scanning direction x, and its shorter side oriented in the secondary scanning direction y. The substrate 1 is attached to the bottom portion of the housing 6, with the plurality of sensor IC chips 3 carried on the substrate 1.

The light source module 2 includes a light source substrate 20, a plurality of terminals 21, three LED chips 22, and a housing 23. The light source substrate 20 is of a rectangular shape and constituted of, for example, a ceramic. Alternatively, the light source substrate 20 may be constituted of a composite material containing a reinforcing member and a polyimide resin, or of a glass epoxy resin. The plurality of terminals 21 serves to connect the light source module 2 to the substrate 1. Each terminal 21 has an end portion formed in a clip shape. The terminals 21 are each attached to the light source substrate 20 via the clip-shaped portion. The three LED chips 22 serve to emit red, green and blue light respectively, and are serially disposed on the light source substrate 20. The housing 23 is, for example, made of a white resin, and encloses therein the three LED chips 22.

Each of the plurality of sensor IC chips 3 is a semiconductor chip of a sleek rectangular shape in a plan view, including a photo-detecting portion (not shown), and corresponds to an example of the photosensor according to the present invention. The sensor IC chips 3 are aligned on the substrate 1 along the primary scanning direction x and, as shown in FIG. 2, located right under the lens array 5. The sensor IC chips 3 have a photoelectric conversion function, and are set to output an image signal of an output level according to the amount of light detected.

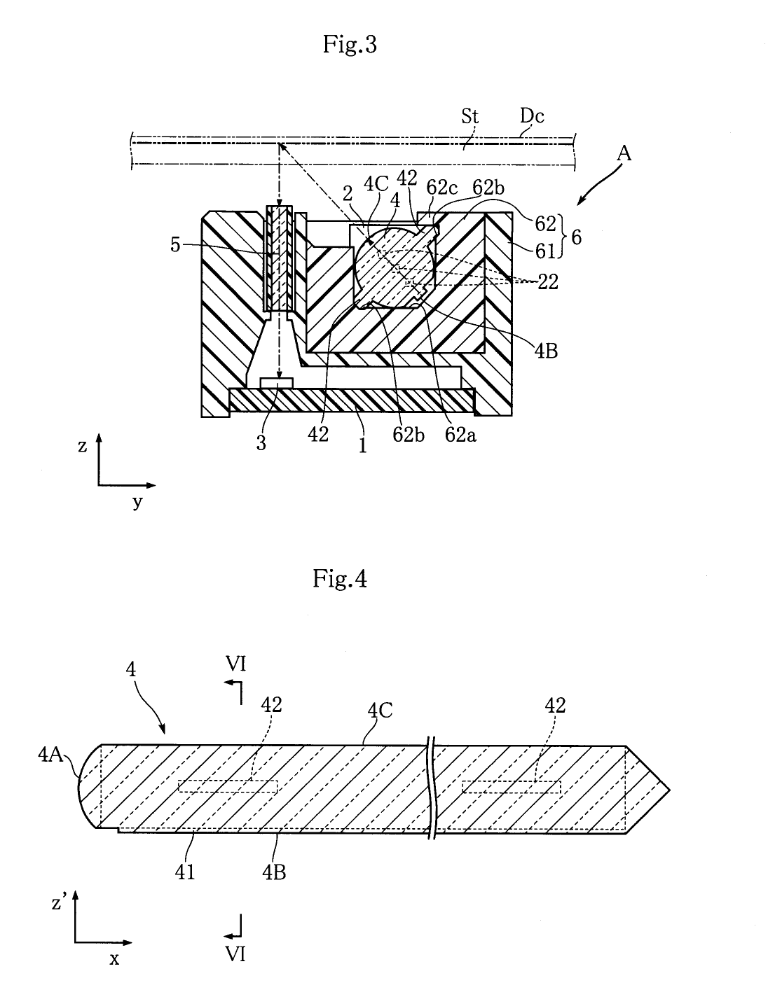

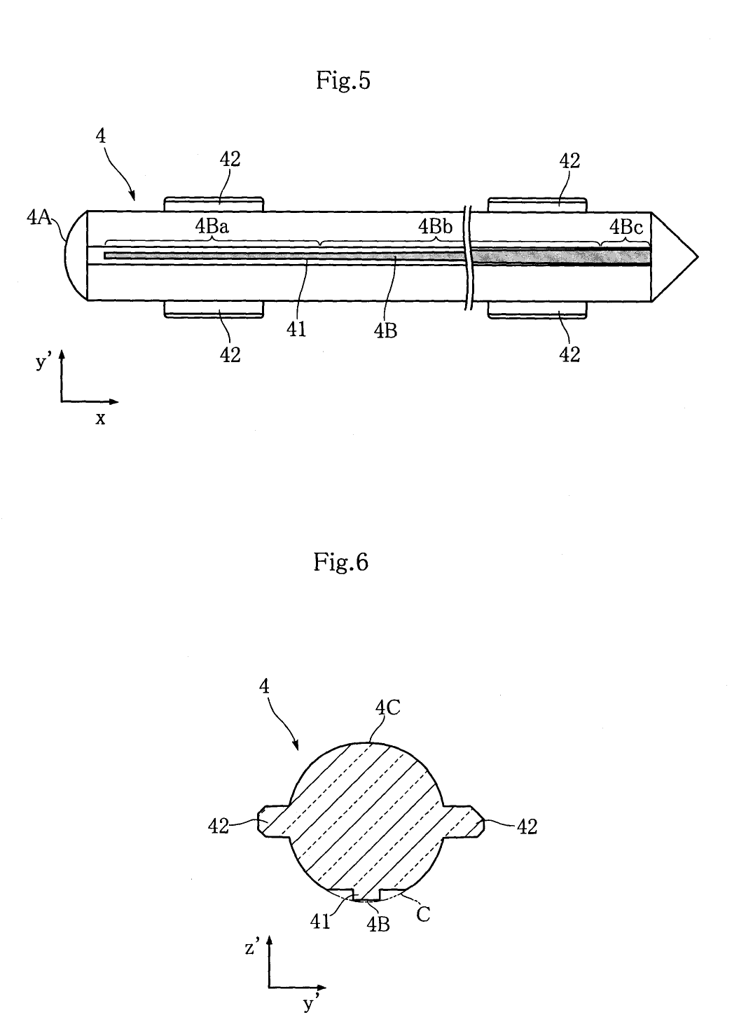

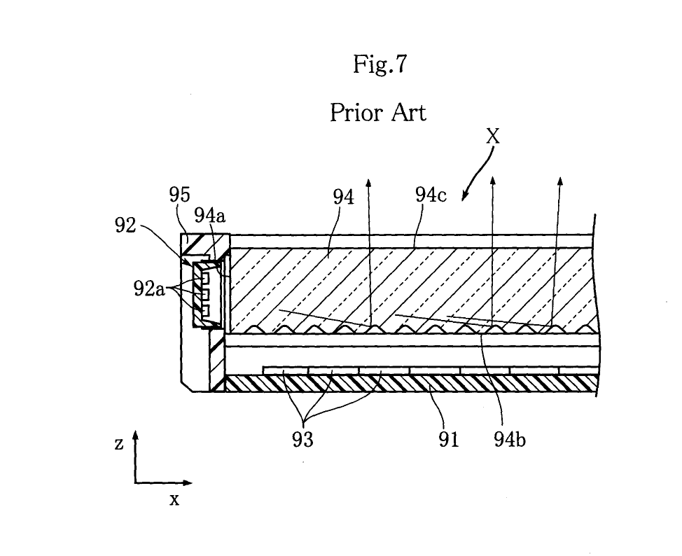

Referring to FIGS. 3 to 6, the light guide 4 is constituted of a highly transparent material such as polymethyl methacrylate (PMMA), generally in a column shape having a generally circular cross-section over the entire length. The light guide 4 is, for example, formed by an injection molding process with a mold, and includes a light receiving surface 4A, a reflecting surface 4B, and a light emitting surface 4C. The light receiving surface 4A serves, as shown in FIG. 1, to introduce the light from the light source module 2 into the light guide 4, and constituted of a facet at an end portion of the light guide 4 in the primary scanning direction x. The light receiving surface 4A is mirror-finished so as to prevent diffusion of the light from the light source module 2, and formed in a mild convex shape in this embodiment, as shown in FIGS. 4 and 5. In this embodiment, the light guide 4 is approximately 230 mm in length, and approximately 4 mm in diameter.

The reflecting surface 4B serves to reflect the light incident thereon in the primary scanning direction x through the light receiving surface 4A, in a direction z′ (light emitting direction) toward the light emitting surface 4C located so as to confront the reflecting surface 4B. As is apparent from FIGS. 4 to 6, the reflecting surface 4B is located on a distal end portion of a ridge 41. The ridge 41 is of a strip shape extending in the primary scanning direction x and having a generally rectangular cross-section. In this embodiment, the distal end portion of the ridge 41 is made flat and painted white, to thereby form the reflecting surface 4B having a diffuse reflection function. Methods of the white painting include a hot stamping process or a screen printing process.

In this embodiment, the ridge 41 includes a region where the width (dimension in a direction y′) thereof varies. To be more detailed, the ridge 41 includes constant width regions 4Ba, 4Bc located close the respective end portions in the primary scanning direction x, and a width-varying region 4Bb located between the constant width regions 4Ba, 4Bc. In the width-varying region 4Bb, the width continuously and uniformly increases toward a position more distant from the light receiving surface 4A. The width-varying region 4Bb substantially occupies a major part of the ridge 41 in the primary scanning direction x. In this embodiment, the ridge 41 is approximately 0.2 mm in height. The constant width region 4Ba is approximately 42 mm in length and approximately 0.2 mm in width; the width-varying region 4Bb approximately 180 mm in length and approximately 0.2 to 0.85 mm in width; and the other constant width region 4Bc approximately 2.2 mm in length and approximately 0.85 mm in width. The ridge 41 thus configured is located, as is apparent from FIG. 6, inside a circle that includes as a part thereof an arcuate portion of the light guide on the respective sides of the ridge 41, in a cross-section taken perpendicular to the primary scanning direction x.

Here, the reflecting surface 4B may be formed as a finely rough surface, instead of the white painting. In this case, the finely rough surface may be formed by roughening a part of the mold for forming the light guide 4, or performing a blasting process over the distal end portion of the ridge 41 after the molding process. Preferably, metal particles of approximately 50 to 200 μm in diameter are employed for the blasting process.

As is apparent from FIGS. 5 and 6, the light guide 4 includes a plurality of rib portions 42 formed so as to project from the surface thereof. The rib portions 42 are located so as to constitute a pair on the respective sides of the direction z′, and a plurality of such pairs is aligned in the primary scanning direction x at a predetermined interval. The rib portion 42 is projecting perpendicular to the primary scanning direction x and also to the direction z′, and has a predetermined length in the primary scanning direction x. It suffices that the rib portion 42 is projecting perpendicular to the primary scanning direction x, and the rib portion 42 does not necessarily have to stick out perpendicular to the direction z′. It suffices that the rib portion 42 sticks out in a direction different from the direction z′, which is the light emitting direction.

The light emitting surface 4C serves to emit the light toward the document Dc, and extends in the primary scanning direction x. Through the light emitting surface 4C, the linear light extending in the primary scanning direction x is emitted.

The lens array 5 serves to converge the light reflected by the document Dc on the sensor IC chips 3 in a form of an erected life-size image. The lens array 5 includes a block-shaped holder extending in the primary scanning direction x, and a plurality of lenses aligned along the primary scanning direction x. The lenses are set such that the optical axis extends in the direction z which is perpendicular to both of the primary scanning direction x and the secondary scanning direction y.

The housing 6 includes a housing main body 61 and a spacer 62 made of a synthetic resin, and is formed generally in a block shape extending in the primary scanning direction x. The housing 6 accommodates therein the substrate 1, the light source module 2, the sensor IC chips 3, the light guide 4, and the lens array 5. To be more detailed, the substrate 1, the light source module 2, and the lens array 5 are attached to predetermined positions on the housing main body 61, and the light guide 4 is attached to the housing main body 61 via the spacer 62.

As shown in FIGS. 2 and 3, the spacer 62 includes a recessed portion 62a that receives the light guide 4, a groove 62b that serves for the positioning of the light guide 4, and a stopper 62c that prevents the light guide 4 from coming off. The recessed portion 62a is wider than the diameter of the light guide 4, and opened upward over the entire length in the primary scanning direction x. The groove 62b is formed for the rib portion 42 of the light guide 4 to fit in, and upon fitting the rib portion 42 therein the light guide 4 assumes a predetermined posture such that the light emitting direction (direction z′) is inclined with respect to the vertical direction. The stopper 62c is provided at such a position that one of the rib portions 42 of the light guide 4 is butted thereto. The stopper 62c serves to retain the light guide 4 in the predetermined posture by getting engaged with the rib portion 42.

It is to be noted that the housing 6 may be formed as a unified body including the housing main body 61 and the spacer 62, instead of the separate structure.

Now, a working effect of the foregoing light guide 4, as well as the image sensor module A including the light guide 4, will be described hereunder.

According to this embodiment, the light emitted by the light source module 2 and introduced into the light guide 4 is reflected by the reflecting surface 4b, and emitted through the light emitting surface 4c. Since the reflecting surface 4b has the uniform diffuse reflection function, the linear light emitted through the light emitting surface 4c has a generally uniform light intensity in the primary scanning direction x. The content of the document Dc can, therefore, be read out properly in the form of image data.

In this embodiment, since the reflecting surface 4B is provided on the distal end portion of the ridge 41, the boundary between the reflecting surface. 4B and the peripheral region can be accurately defined, despite the generally circular cross-sectional shape of the light guide 4. Such configuration is advantageous for equalizing the light intensity over the entirety of the linear light emitted through the light emitting surface 4C.

In this embodiment, the reflecting surface 4B provided on the distal end portion of the ridge 41 is formed by painting the distal end portion in white. In this case, the reflecting surface 4B can be easily formed by pressing the distal end portion of the ridge 41 against a white paint or film to thereby transfer the white color. The foregoing arrangement allows, therefore, forming the light guide 4 through an easy and simple process. The light guide 4 also includes the rib portions 42 projecting perpendicular to the light emitting direction z′, located on an outer surface of the light guide and on the respective sides of the light emitting surface. The rib portions 42 serve to minimize the backlash of the light guide 4 thereby securely positioning the same, when the white painting is performed.

The amount of light introduced through the light receiving surface 4A and traveling through the light guide 4 tends to decrease as proceeding away from the light receiving surface 4A. In the present embodiment, however, the reflecting surface 4B includes the width-varying region 4Bb where the width increases as proceeding away from the light receiving surface 4A. Such configuration is advantageous for equalizing the light intensity over the entire length of the linear light emitted through the light emitting surface 4C.

Also, the end portion of the reflecting surface 4B closer to the light receiving surface 4A is formed as a constant width region 4Ba having a relatively narrow width. Such configuration is adopted due to the fact that the amount of light that reaches the region 4Ba is sufficiently large in the vicinity of the light receiving surface 4A. On the other hand, the other end portion of the reflecting surface 4B, which is farther from the light receiving surface 4A, is formed as a constant width region 4Bc having a greater width than the region 4Ba. Such configuration is adopted by taking into account the light that proceeds in the primary scanning direction x and reaches the end of the light guide, as well as the returning light reflected on the end. The foregoing structure further contributes to equalize the light intensity over the linear light emitted through the light emitting surface 4C.

The housing 6 (and the spacer 62) which accommodates therein the light guide includes the groove 62b for the rib portion 42 of the light guide 4 to fit in, and the stopper 62c for getting engaged with the rib portion 42. Such structure permits firmly holding the light guide 4 of the generally circular cross-sectional shape at the predetermined orientation and position, with respect to the housing 6. Accordingly, the light guide 4 and the light source module 2 attached to the housing 6 are constantly maintained in the desired positional relationship. Such configuration is advantageous for leveling the light intensity over the linear light emitted through the light emitting surface 4C.

The light guide and the image sensor module according to the present invention are not limited to the foregoing embodiments. The structure of the respective portions of the light guide and the image sensor module according to the present invention may be modified in various manners. For example, in the above embodiment, the ridge on which the reflecting surface is provided includes the region where the width continuously increases as proceeding away from the light receiving surface. Alternatively, the width of the ridge may increase stepwise as proceeding away from the light receiving surface. Further, in place of the ridge continuously extending in the longitudinal direction of the light guide, a plurality of ridges may be provided at appropriate intervals in the longitudinal direction of the light guide.

1. An elongated and generally columnar light guide, comprising:
a light receiving surface provided at an longitudinal end portion of the light guide;
a reflecting surface elongated in a longitudinal direction of the light guide for reflecting light entering through the light receiving surface in a light emitting direction;
a ridge elongated in the longitudinal direction; and
a light emitting surface for emitting reflected light from the reflecting surface as linear light extending in the longitudinal direction;
wherein the reflecting surface is provided on a distal end portion of the ridge.

2. The light guide according to claim 1, wherein the reflecting surface is white.

3. The light guide according to claim 1, wherein the reflecting surface is a finely rough surface.

4. The light guide according to claim 1, wherein the ridge includes a region where a width thereof continuously increases as proceeding away from the light receiving surface in the longitudinal direction.

5. The light guide according to claim 1, further comprising a pair of rib portions flanking the longitudinal direction, wherein each of the rib portions projects in a direction perpendicular to the longitudinal direction and different from the light emitting direction.

6. An image sensor module comprising:
an elongated and generally columnar light guide;
a light source module adjacent to the light guide;
a housing accommodating the light guide; and
a plurality of photosensors aligned in a longitudinal direction of the light guide for detecting linear light reflected by an object to be read;
wherein the light guide includes: a light receiving surface provided at an longitudinal end portion of the light guide and facing the light source module; a reflecting surface elongated in the longitudinal direction for reflecting light entering through the light receiving surface in a light emitting direction; a ridge elongated in the longitudinal direction; and a light emitting surface for emitting reflected light from the reflecting surface as linear light extending in the longitudinal direction; the reflecting surface being provided on a distal end portion of the ridge.

7. The image sensor module according to claim 6, wherein the light guide further comprises a pair of rib portions flanking the longitudinal direction, each of the rib portions projecting in a direction that is perpendicular to the longitudinal direction and different from the light emitting direction, and wherein the housing is formed with grooves elongated in the longitudinal direction and coming into engagement with the rib portions of the light guide.
